(19) United States
(12) Patent Application Publication
(10) Pub. No.: US 2014/0025576 A1
(43) Pub. Date: Jan. 23, 2014

(54) Mobile Check-In

(71) Applicant: Darrell Esch, San Jose, CA (US)

(72) Inventor: Darrell Esch, San Jose, CA (US)

(73) Assignee: eBay, Inc., San Jose, CA (US)

(21) Appl. No.: 13/554,407

(22) Filed: Jul. 20, 2012

(51) Int. Cl. G06Q 20/40

(52) U.S. Cl. 705/44

(57) ABSTRACT

Methods and systems can facilitate more convenient shopping by users of a payment provider, such as Paypal, Inc. A user can purchase a product simply by swiping a card without being required to enter additional information, such as the user's personal identification number (PIN). Thus, the checkout process at the point-of-sale can be performed more easily and quickly. More particularly, a user can open an app on a mobile device and sign in to a payment provider system using the app. The app can show merchants near the user. The user can select one or more of the merchants. Selecting a merchant allows the user to check in with the merchant. Checking in with the merchant can result in pre-authorization of a purchase by the user with the merchant.

### BACKGROUND

1. Technical Field

The present disclosure generally relates to electronic commerce and, more particularly, relates to mobile check-in whereby a user can be authenticated with one or more selected merchants prior to visiting the merchant(s) so as to streamline a point-of-sale checkout process.

2. Related Art

The use of electronic payment methods at brick and mortar stores is well known. Such electronic payment methods include the use of credit cards, gift cards, and payment providers, such as Paypal, Inc. Electronic payment methods reduce the need for customers to carry cash and similarly reduce the need for merchants to process cash. Reducing the need for cash benefits both the customers and the merchants. Thus, electronic payment methods are generally desirable by both the customers and the merchants.

However, the use of electronic payment methods generally requires that an authentication process be performed for each purchase transaction. The authentication process provides some assurance that the customer is using the electronic payment method legitimately. The authentication process can take longer than desired and can be inconvenient. Typically, the customer, the checkout clerk, and all of the other customers in line must wait while the authentication process is being performed. Thus, the authentication process can undesirably slow down purchase transactions. Slowing down the purchase transactions can result in longer lines. Longer lines can discourage potential customers from shopping with a merchant, thereby resulting in lost sales.

In view of the foregoing, it is desirable to streamline purchase transactions at brick and mortar stores. More particularly, it is desirable to reduce the amount of time spent by customers in the authentication process.

### BRIEF DESCRIPTION OF THE DRAWINGS

FIG. 1 is a block diagram of a system for providing mobile check-in, according to an embodiment;

FIG. 2 is a flow chart showing a method for providing mobile check-in, according to an embodiment;

FIG. 3 is a flow chart showing further detail of the method for providing mobile check-in, according to an embodiment; and

FIG. 4 is a block diagram of an example of a computer that is suitable for use in the system for mobile check-in, according to an embodiment.

### DETAILED DESCRIPTION

Methods and systems are provided for facilitating more convenient shopping by users of a payment provider, such as Paypal, Inc. According to an embodiment, a user can purchase a product simply by swiping a card without being required to enter additional information, such as the user's personal identification number (PIN). Thus, a checkout process at the point-of-sale can be performed easily and quickly.

More particularly, a user can open an app on a mobile device and sign in or log on to a payment provider system using the app. For example, the user can sign in to a web site that is hosted by the payment provider. The app can show or list merchants that are near the location of the user. The merchants can be shown either graphically or via text. The user can select one or more of the merchants. Selecting a merchant allows the user to check in with the merchant. Checking in with the merchant can result in pre-authorization of a purchase by the user with the merchant.

Such pre-authorization can be somewhat similar to the authorization process commonly performed at the time of checkout at the point-of-sale, according to contemporary practice. Thus, once the user has checked in or obtained pre-authorization with the merchant, the checkout process can be substantially simplified since authorization of the transaction with the payment provider is no longer necessary or is substantially simplified. Checkout with the merchant can merely involve a confirmation of a purchase. The confirmation of the purchase can be done by swiping a card, signing a receipt, receiving the purchased products, or by any other means.

According to an embodiment, a photograph of the user can be provided by the mobile check-in system to the merchant. The photograph can appear on a display of the merchant, on a sales receipt, or in any other desired manner. The photograph can be used by the merchant to help identify the user. For example, the merchant can compare the photograph to the user to verify that the pre-authenticated user and the customer making the purchase are the same person.

According to an embodiment, a system can include a memory that stores account information for a user and stores account information for a plurality of merchants. One or more processors can cooperate to receive a communication, such as from the user, which includes an indication of a desire of the user to shop at one or more merchants within a defined area. The processor(s) can access the memory to verify that the user is an authorized user and that the merchant(s) are participating merchants. Participating merchants are merchants who have agreed with the payment provider to participate in the mobile check-in system. The processor(s) can send a pre-authorization to the merchant(s) if the user is an authorized user and the merchant(s) are participating merchants.

The pre-authorization can facilitate purchases by the user at one or more of the merchant(s) simply by swiping a card, such as a payment provider card, without having to enter any additional information. Thus, the user can check out at the point-of-sale in substantially the same manner as is done during a contemporary check out, except that no PIN or other information needs to be entered or otherwise provided by the user (other than by swiping the card) and except that there is no wait for authorization from the card company. Thus, the checkout process can be substantially speeded up. Speeding up the checkout process can shorten checkout lines, reduce the inconvenience commonly associated with the contemporary checkout procedure, and generally enhance the shopping experience.

In another embodiment, the user can simply enter a user phone number and PIN at a point of sale device at the merchant location, which eliminates the need to swipe a payment card. This can be advantageous if the user did not bring the card to the merchant location.

The communication can include a location of the user. For example, the communication can include a GPS location of the user, such as a GPS location provided by a GPS of a mobile device of the user when the user accesses an app on the mobile device. The location of the user can be obtained in any other fashion. For example, the location of user can be obtained from a recent purchase transaction since during the recent purchase transaction the user was at a known location at a known time. Thus, after shopping with one merchant at a location, the user can be pre-authorized to make purchases with other nearby merchants.

The pre-authorization can be sent to all of the participating merchants within the defined area. Alternatively, the pre-authorization can be sent only to selected ones of the participating merchants within the defined area. For example, the user can select which ones of the participating merchants are to receive the preauthorization.

The defined area can be within a predetermined distance from the user. The processor(s) can use the location of the user in combination with a database of merchant locations to determine which of participating merchants are to receive the pre-authorization, e.g., which of the participating merchants are within the predetermined distance from the user.

For example, the defined area can be within one, two three, four, five or more blocks of the user. The defined area can be a predefined geographic area. For example, the defined area can be a city or a portion of a city. The defined area can be a designated shopping area. For example, the defined area can be a shopping area of a city or can be a shopping mall. The area may change depending on the location. For example, the area may be smaller in a densely populated shopping area, such as a mall, or be larger in rural or more sparsely populated shopping areas.

The defined area can be an area wherein the merchants are within a predetermined time from user. For example, the defined can be an area wherein all of the merchants are within ten minutes of the user. Thus, if the user is assumed to be walking, then the defined area can be within a ten minute walk of the user, assuming that the user walks at a particular rate, e.g., one mile per hour. Similarly, if the user is assumed to be driving, then the defined area can be within a ten minute drive of the user, assuming that the user drives at a particular rate, e.g., twenty-five miles per hour.

The pre-authorization can be a pre-authorization to make purchases up to a predetermined money limit. The pre-authorization can be a pre-authorization to make purchases up to a predetermined money limit for each individual merchant. The pre-authorization can be a pre-authorization to make purchases up to a predetermined total money limit for all merchants combined.

The processor(s) can access the memory to determine an available credit amount for the user and the pre-authorization can be a pre-authorization to make purchases up to an available credit amount for the user. The pre-authorization can be for a predetermined length of time.

The processor(s) can send a photograph of the user to the merchant(s). The photograph can be used by the merchant(s) to help identify the user. Thus, the merchant can compare the photograph to the person making the purchase to verify that the person making the purchase is the pre-authenticated user.

The processor(s) can be further operable to receive a communication that is indicative that the card of the user was swiped or from a mobile number plus PIN entered by the user. The swiping of the card or entry of the information can indicate to the processor(s) that the purchase transaction at the store was completed or in process. The processor(s) can then complete any processing necessary to facilitate payment from the user to the merchant for the products purchased

According to an embodiment, a method can include storing, in a memory, account information for a user and storing account information for a plurality of merchants. A communication can be received, electronically by one or more processors. The communication can include an indication of a desire of a user to shop at one or more merchants within a defined area. The processors can access the memory to verify that the user is an authorized user and that the merchant(s) are participating merchants. A pre-authorization can be sent by the one or more processors to the merchant(s) if the user is an authorized user and the merchant(s) are participating merchants.

According to an embodiment, a computer program product can comprise a non-transitory computer readable medium. The non-transitory computer readable medium can store computer readable and executable code for instructing the one or more processors to perform the method.

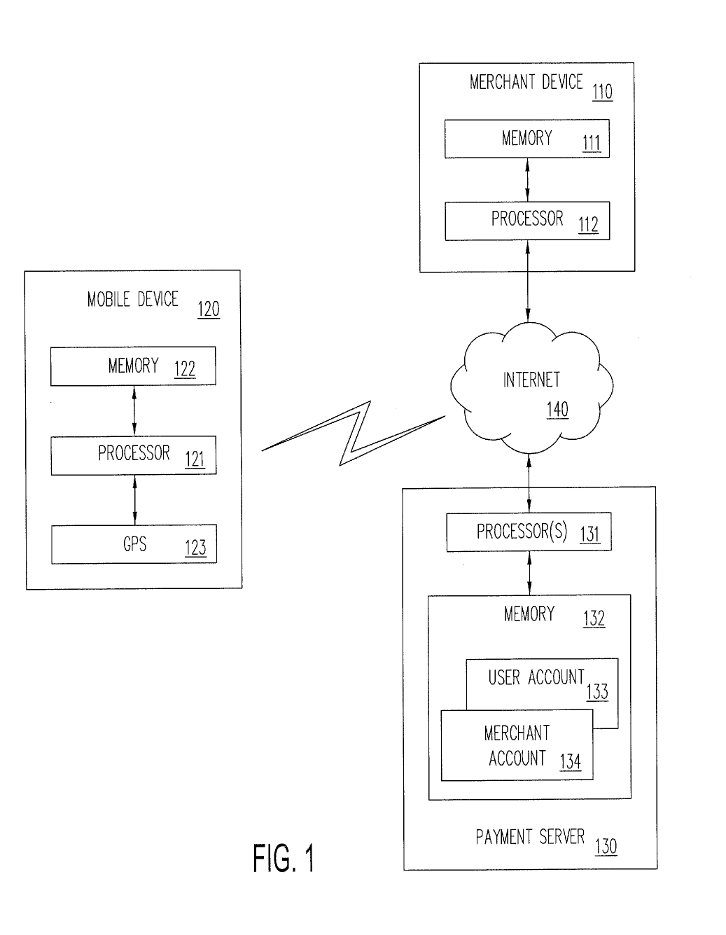

FIG. 1 is a block diagram of a system for mobile check-in, in accordance with an embodiment. The system can include a merchant device 110. The merchant device 110 can be a merchant checkout terminal, a computer, and/or a server, for example. The merchant device 110 can include a memory 111 and a processor 112. The merchant device can be located at a point-of-sale or can be located elsewhere.

The system can include a mobile device 120. The mobile device 120 can be carried by the user. The mobile device 120 can be a cellular telephone, a smart telephone, a hand held computer, or a tablet computer, for example. The mobile device can include a processor 121, a memory 122, and a global positioning system (GPS) 123.

The system can include a payment server 130. The payment server can be a server of a payment provider, such as Paypal, Inc. The payment server 130 can be a single server or can be a plurality of servers. The payment server 130 can include one or more processors 131 and a memory 132. The memory 132 can be a memory of the payment server 130 or a memory that is associated with, e.g., in communication with, the payment server 130. The memory 132 can be a distributed memory. The memory 132 can store a user account 133 and a merchant account 134.

The merchant device 110, the mobile device 120, and the payment server 130 can communicate with one another via a network, such as the Internet 140. The merchant device 110, the mobile device 120, and the payment server 130 can communicate with one another via any one or a combination of a plurality of networks, such as local area networks (LANs), wide area networks (WANs), cellular telephone networks, and the like.

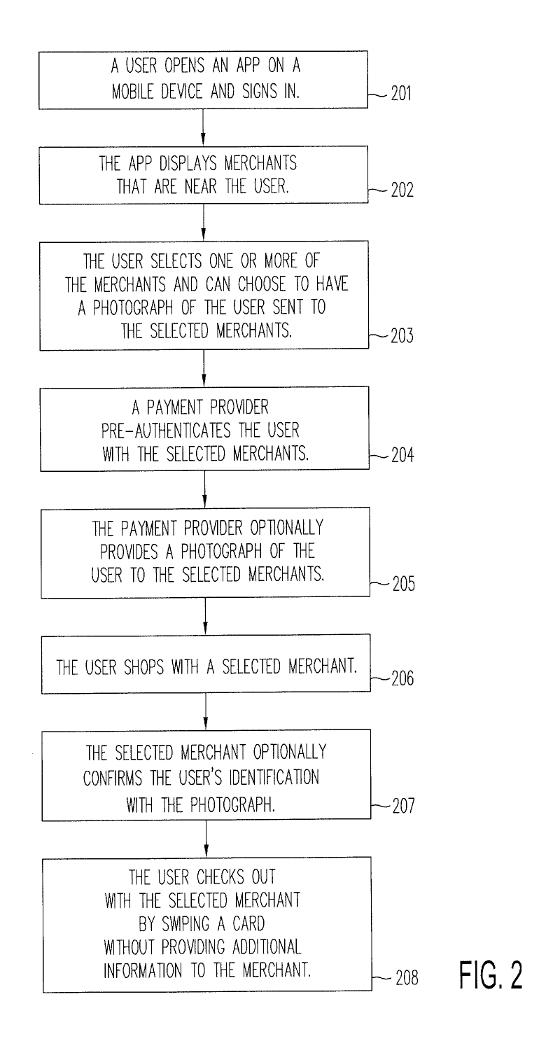

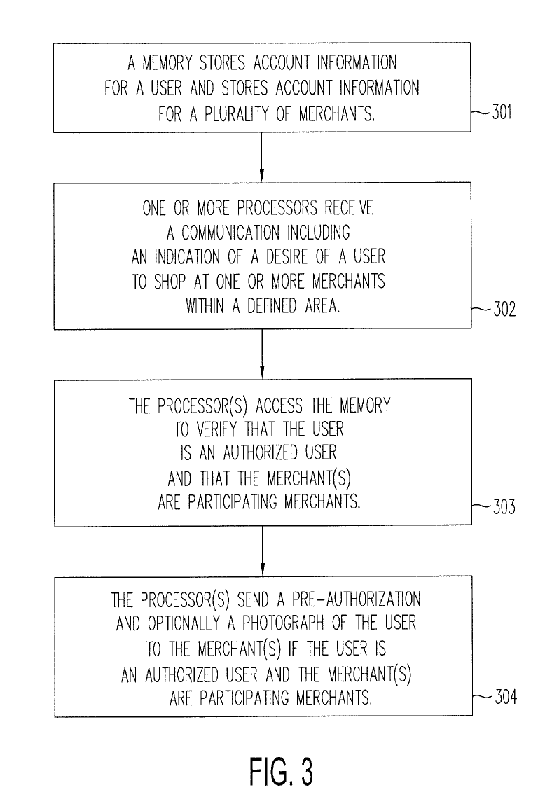

FIGS. 2 and 3 are flow charts that describe examples of operation of the system for providing mobile check-in according to embodiments thereof. Note that one or more of the steps described herein may be combined, omitted, or performed in a different order as desired or appropriate.

FIG. 2 is a flow chart showing a method for providing mobile check-in, according to an embodiment. A user can open an app, such as on the mobile device 120 and can sign in or log on, as shown in step 201. The user can sign in to the app or to a web site, such as a web site of the payment provider. The web site can be hosted on the payment server 130 or on any other server.

The user can provide information during the app sign in process that facilitates pre-authentication of the user. For example, the user can enter a PIN during the sign in process. Entry of the information, e.g., the PIN, during the sign in process can take the place of entry of the information during checkout for one or more purchases from one or more merchants. Thus, the information does not have to be entered during the checkout for the one or more purchases from one or more merchants.

The app can display merchants that are near the user, as shown in step 202. The app can provide a list, such as a text list, of the merchants. The app can show the merchants graphically. The app can show the merchants on a map. The merchants can be communicated from the mobile device 120 to the user in any desired manner.

For example, the list of the merchants can be read verbally to the user, such as via a speech synthesizer of the mobile device 120. Reading the list verbally can be convenient when the user is driving, for example. Reading the list verbally can be particularly beneficial to the sight impaired.

The user can select one or more of the merchants and can choose to have a photograph of the user sent to the selected merchants, as shown in step 203. The user can select one of the merchants by dropping a pin displayed on the mobile device 120 onto a designated area shown on the mobile device 120. The pin can be representative of the merchant. For example, each of the merchants can have a dedicated pin. Alternatively, the designated area can be representative of the merchant. For example, each of the merchants can have a designated area upon which a pin can be dropped. The designated area can be the location of the merchant on a map, a name of the merchant on a list, or any other text or graphic.

The selected merchant(s) can be those merchants at which the user intends to shop. In this manner, the user can designate those merchants where the user intends to shop so that the mobile check-in system, e.g., the payment server 130 of the mobile check-in system, can pre-authorize the user for use of a card at the stores of the merchants. The user can select the merchants individually, e.g., by specifying each individual merchant. Alternatively, the user can select a group of the merchants, e.g., by selecting all of the merchants within a given area (such as the area where the user is located at the time of the selection).

The user can choose to have a photograph of the user sent to one or more of the selected merchants. The user can choose which of the selected merchants are to receive the photograph of the user on a merchant by merchant basis. The photograph can be a stored photograph (such as a stored photograph from the payment server 130) of the user or can be a substantially real-time photograph of the user (such as a photograph just taken by the user via the mobile device 120).

The user can choose to have other desired information sent to one or more of the selected merchants. The other information can be any other information designated by the user. The other information can be designated by the user in real-time, e.g., at approximately the time that the user is selecting the merchants. The other information can be designated by the user during a set up process for the mobile check-in system. The other information can include a physical description of the user, a telephone number of the user, an address of the user, credit card information, bank card information, gift card information, or any other information.

The payment provider can pre-authenticate the user with the selected merchants, as shown in step 204. Such pre-authentication can include any processes that are performed during a contemporary authentication at a point-of-sale during check-out. Such pre-authentication can be for a limited money amount. That is, according to an embodiment any purchase made by the user from one of the merchants must be for a money amount that is less than or equal to the limited money amount of the pre-authentication. Any purchase in excess of this amount can be authorized in the contemporary manner.

The pre-authorization can be for a total money amount for all purchases made at the selected merchants or can be for a separate money amount for each merchant. The pre-authorization can be for a different money amount for each merchant or can be for the same money amount for each merchant.

The pre-authorization can be limited to products or types of products. For example, the pre-authorization can be limited to food, clothing, automobile parts, or any other types of product. Such limits regarding the products that can be purchased using pre-authorization can be determined by the user, such as during the set up process for the user. Such limits regarding the products that can be purchased using pre-authorization can be determined by the merchant, such as during the set up process for the merchant.

In another example, the pre-authorization can be limited by time. For example, if a selected merchant has a large store with a sale going on, and the user has a history of making large numbers of purchases at the merchant during single shopping sessions, the pre-authorization may be two hours or more. In contrast, if a selected merchant is a small store with a limited inventory, and the user has only purchased one or two items during shopping sessions with this merchant, the pre-authorization may be only 30 minutes. Thus, the time may be based on the type of merchant, the particular store, user shopping history with the merchant, with similar merchants, or in general, and/or other information as appropriate.

The pre-authorization can be limited or modified in any manner and according to any criteria. The limits can be defined by the user, the merchant, the payment provider, a regulatory body, a government agency, or any other entity. The limits can be changed at any time by the user, the merchant, or the payment provider.

Such limits regarding the products that can be purchased using pre-authorization can be defined by the payment provider. For example, the payment provider may have recently experienced increased fraud in the purchase of jewelry and in response can halt or suspend the use of pre-authorization for purchases of jewelry. Such limits can additionally be location based. For example, the payment provider may have recently experienced increased fraud in the purchase of gold jewelry in the Los Angeles jewelry district and in response the payment provider can halt or suspend the use of pre-authorization for purchases of gold jewelry only in the Los Angeles jewelry district.

In a similar manner, the merchant can halt or suspend the use of pre-authorization. However, in this instance, limitation would be with respect to the merchant only or with respect to stores owned or controlled by a common merchant, e.g. chain stores.

The limited money amount can be determined by the user, such as in a set up process for the user. The limited money amount can be determined by the merchant, such as in a set up process for the merchant. The limited money amount can be determined by the payment provider, such as in the manner that a credit limit for the user is determined. The pre-authentication can include the payment server 130 sending a communication to each of the selected merchants to pre-authorize purchases. The purchases can be preauthorized up to a limited money amount and for a limited amount of time, as discussed herein.

In response to the user selecting the merchants, a communication can be sent to the user confirming the pre-authentication. The communication can be sent from the payment server 130 or the user device 120. The communication can be sent from any other computer, server, or device. The communication can be sent via email, text messaging, voice, or any other method.

In response to the user selecting the merchants, a communication can be sent to the user providing the user with information. The information can be communicated from the merchant device 110 or the payment server 130. The information can be information regarding the location or hours of the merchant(s). For example, the information can include a map showing the location of the merchant. The map can have a route from the user to the location of the merchant. The route can be high lighted on the map. The payment server 130 can use the GPS location of the user and the stored location of the merchant to make the map.

The information can include a picture of the storefront of the merchant to help the user find the merchant. The information can include pictures of products, catalogs, prices, menus, or any other information that can be of use to the user or that can entice the user to visit the merchant.

The information can be information regarding incentives, e.g., specials or discounts, offered by the merchant(s). Such specials or discounts can expire in a short time, so as to entice the user to shop with the merchant immediately. For example, the user can be offered 25% off for a meal at a selected restaurant if the meal is purchased within one hour or the user can be offered 15% off for all apparel at a selected clothing store if the apparel is purchased that day. The information can be provided in the same communication as the confirmation.

The communication can include announcements from the merchants. For example, the communication can include announcements regarding the opening of a new store or a special event such as a barbeque at a new car dealer.

The communication can include a software program or app of the merchant. The app can help the user determine what to purchase at the store, have the store put any selected items on hold or layaway for the user, or allow the user to ask questions about products sold by the merchant. The questions can be answered by the merchant device 110 or by a person employed by the merchant.

The communication can be sent from the merchant device 110, such as immediately after the pre-authorization is communicated from the payment server 130 to the merchant device 110. The communication can be sent from the merchant device 110 to the user mobile device 120. For example, the communication can be sent from the merchant device 110 to the user mobile device 120 via the Internet 140, via a cellular telephone network, or via any other means. The communication can be an email, a text message, a voice message, or any other type of communication. The communication can be an invitation to visit a web site of the merchant.

The payment server 130 can maintain a database of merchant incentives. For example, the payment server 130 can store such merchant incentives in the merchant account 134 of the memory 132. Thus, the payment server 130 can send the communication to the user mobile device 120. For example, the communication can be sent from the payment server 130 to the user mobile device 120 via the Internet 140, via a cellular telephone network, or via any other means. The communication can be an email, a text message, a voice message, or any other type of communication. The communication can be an invitation to visit a web site of the merchant.

The payment server 130 can optionally provide a photograph of the user to the selected merchants, as shown in step 205. The photograph can be a photograph that was provided by the user to the payment provider during a set up process. The user can determine whether or not the photograph is to be provided to the merchants. Each merchant can determine whether or not a photograph is required for pre-authentication. Each merchant can determine whether or not a photograph is to be received for pre-authentication.

The user can shop with a selected merchant, as shown in step 206. The user can shop at one or more of the selected merchants. The user can shop with any desired number of the selected merchants. The user is not obligated to shop with any of the merchants.

The user can be offered an incentive by the payment provider to use the mobile check-in system for pre-authorizing purchases. For example, the user can be offered points, merchandise, reduced fees, or reduced interest rates on balances owed by the user to the payment provider. In this manner, more users can be enticed to use the mobile check-in system. The increased user base can provide the payment provider a competitive advantage in the electronic commerce market.

The selected merchant can optionally confirm the user's identification with the photograph, as shown in step 207. Each merchant can decide individually whether or not to confirm the user's identification with the photograph. Thus, some merchants can decide to confirm the user's identification with the photograph while other merchants can decide not to confirm the user's identification with the photograph. Each merchant can further decide whether or not additional identification of the user or other information from the user is required.

The user can check out with the selected merchant by swiping a card of the user and without providing additional information to the merchant, as shown in step 208, or the user can enter a phone number, or other identifier, and a PIN or password at the merchant location. Alternatively, the merchant can require additional information. In general, pre-authorization can speed up the check out process by providing the merchant with any required information prior to the purchase. For example, the merchant can determine in advance, such as during a set up process, what information the merchant requires for customer check out and the payment server 130 can automatically provide the merchant device 110 with such information at the time of checkout or prior to checkout.

For example, if the merchant requires a telephone number and an address, then the payment server 130 can automatically provide the merchant with such information at the time of checkout or prior to checkout. The user can be queried for such information if the payment server 130 does not have the information. The user can determine what, if any, such information is to be provided by the payment server 130 to the merchant.

The swiping of the card can be used merely to document and conclude the purchase transaction. No authentication is necessary since the user and the purchase have been pre-authenticated. Alternatively, the information from the card can be used to further authenticate the user. For example, the information from the card can be used by the merchant device 110, the payment server 130, or any other computer, server, or device to determine that the card is not lost or stolen, is valid, that a credit limit is not being exceeded, that the purchaser is the user, or for any other purpose.

The location of the user can be verified during the checkout process. For example, the location of the user can be verified by querying the user device 120 for the GPS of the user. By verifying the location of the user, the mobile check-in system can determine whether or not the user is likely to the be person making the purchase. For example, if the user is determined to be at the same location as the merchant, then it can be assumed with confidence that the purchaser is the user and the purchase transaction should be permitted. However, if the user is determined to be at a location that is distant from the location of the merchant, then it can be assumed with confidence that the purchase is not the user and the purchase transaction can be halted or more information, e.g., identification, can be required from the purchaser.

FIG. 3 is a flow chart showing further detail of the method for providing mobile check-in, according to an embodiment. A memory 132 stores account information for a user and the memory 132 also stores account information for a plurality of merchants, as shown in step 301. The merchants can be participating merchants. The memory 132 can be a memory of the payment server 130, for example. The memory 132 can be a memory of any other computer, server or device.

Participating merchants are merchants who have decided to participate in the pre-authentication or mobile check-in system. Not all of the merchants who subscribe to or have accounts with the payment provider are necessarily participating merchants. Not all of the merchants who have account information stored in the memory 132 are necessarily participating merchants.

One or more processors 131 can receive a communication including an indication of a desire of a user to shop at one or more merchants within a defined area, as shown in step 302. The processor(s) 131 can be processors of the payment server 130, for example. The processor(s) 131 can be processors of any other computer, server or device. The communication can be from the user. For example, the communication can be from an app the mobile device 120 of the user.

The processor(s) 131 can access the memory 132 to verify that the user is an authorized user and that the merchant(s) are participating merchants, as shown in step 303. The processor(s) 131 can send a pre-authorization and can optionally send the photograph of the user to the merchant(s), if the user is an authorized user and the merchant(s) are participating merchants, as shown in step 304. The processor(s) 131 can send the pre-authorization and the photograph to the merchant device 110. If the user is not an authorized user, the process can be halted. If any of the merchants are not participating merchants, then the pre-authorization can be omitted for the non-participating merchants.

For example, a merchant can be listed by the app for the user to select, but could recently have declined further participation in the pre-authorization or mobile check-in system. The app may not have yet received an update to delete the merchant. Thus, the user can select a particular merchant and the payment server 130 can refuse to pre-authorize the particular merchant.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

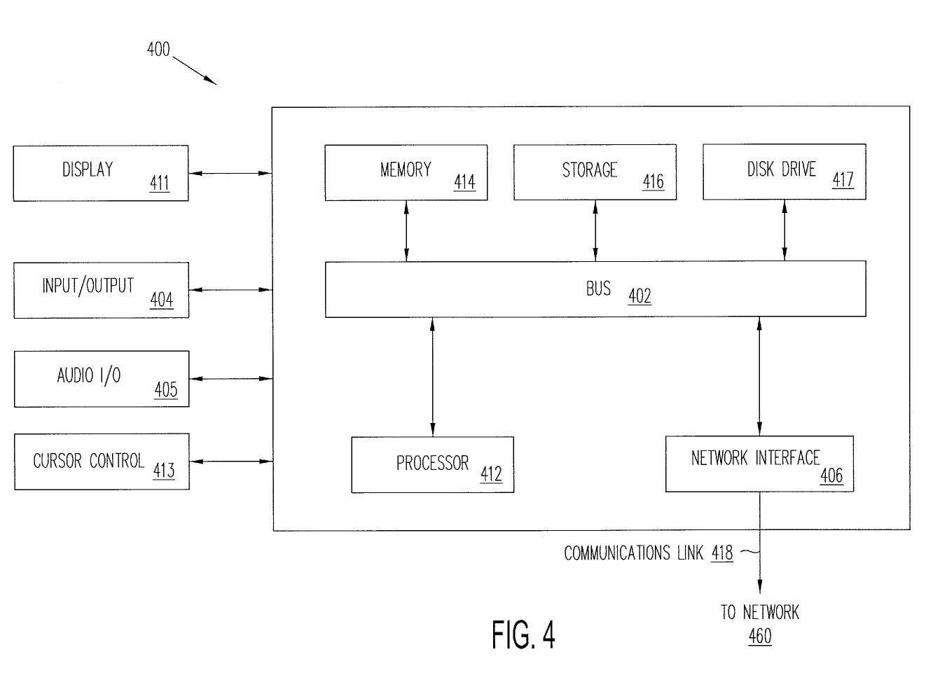

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (110) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used herein, the term “card” can include cards that are used by consumers to purchase products from merchants. Examples of such cards can include credit cards, bank cards, gift cards, and payment provider cards.

As used herein, the term “product” can include any item or service. Thus, the term “product” can refer to physical products, digital goods, services, or anything for which a user can make a payment, including charitable donations. A product can be anything that can be sold.

As used herein, the term “store” can include any business or place of business. The store can be a brick and mortar store or an online store. The store can be any person or entity that sells a product.

As used herein, the term “merchant” can include any seller of products. The term merchant can include a store. The products can be sold from a store or in any other manner. Generally, the terms “store” and “merchant” can be used interchangeably herein.

As used herein, the term “mobile device” can include any portable electronic device that can facilitate data communications, such as via a cellular network and/or the Internet. Examples of mobile devices include cellular telephones, smart phones, tablet computers, and laptop computers.

Thus, according to one or more embodiments, the mobile check-in system can use the location of the user for authentication. The known location of the user, such as via GPS from the user's mobile device 120, provides a degree of confidence in authorizing purchase transactions for the user in the area where the user is known to be located. The user can be authenticated through the app login and verified through the location of the mobile device 120, e.g., telephone.

According to one or more embodiments, the check out process is streamlined such that the user can complete the check out process more quickly. Completing the check out process more quickly benefits the user, the merchant, and any other consumers in line with the user.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a memory storing account information for a user and storing account information for a plurality of merchants;
one or more processors operable to:
receive, from a user mobile device, a communication including an indication of a desire of the user to shop at one or more merchants within a defined area;
access the memory to verify that the user is an authorized user and that the merchant(s) are participating merchants; and
send a pre-authorization to the merchant(s) if the user is an authorized user and the merchant(s) are participating merchants.

2. The system of claim 1, wherein the indication of the desire is from the user checking into a merchant location through a mobile application on the user mobile device.

3. The system as recited in claim 1, wherein the pre-authorization facilitates a purchase by the user at the merchant(s) by swiping a card without having to enter any additional information.

4. The system as recited in claim 1, wherein the communication includes a location of the user.

5. The system as recited in claim 1, wherein the processor(s) send the pre-authorization to all of the participating merchants within the defined area.

6. The system as recited in claim 1, wherein the processor(s) send the pre-authorization to user selected ones of the participating merchants within the defined area.

7. The system as recited in claim 1, wherein the defined area is within a predetermined distance from the user.

8. The system as recited in claim 1, wherein the defined area is a predefined geographic area.

9. The system as recited in claim 1, wherein the defined area is a designated shopping area.

10. The system as recited in claim 1, wherein the pre-authorization is a pre-authorization to make purchases up to a predetermined money limit.

11. The system as recited in claim 1, wherein the pre-authorization is a pre-authorization to make purchases up to a predetermined money limit for each merchant.

12. The system as recited in claim 1, wherein the pre-authorization is a pre-authorization to make purchases up to a predetermined total money limit for all merchants combined.

13. The system as recited in claim 1, further comprising:
the processor(s) accessing the memory to determine an available credit amount for the user; and
wherein the pre-authorization is a pre-authorization to make purchases up to the available credit amount for the user.

14. The system as recited in claim 1, wherein the pre-authorization is for a predetermined length of time.

15. The system as recited in claim 1, further comprising the processor(s) sending a photograph of the user to the merchant(s).

16. The system as recited in claim 1, wherein the processor(s) are further operable to receive a communication indicative that a card of the user was swiped and a purchase transaction at the store was completed.

17. The system as recited in claim 1, further comprising the processor(s) sending a confirmation of the pre-authentication to the user.

18. The system as recited in claim 1, further comprising the processor(s) sending a confirmation of the pre-authentication to the user via text messaging.

19. A method comprising:
storing, in a memory, account information for a user and account information for a plurality of merchants;
receiving, electronically by one or more processors, a communication including an indication of a desire of the user to shop at one or more merchants within a defined area;
accessing, by the one or more processors, the memory to verify that the user is an authorized user and that the merchant(s) are participating merchants; and
sending, by the one or more processors, a pre-authorization to the merchant(s) if the user is an authorized user and the merchant(s) are participating merchants.

20. A computer program product comprising a non-transitory computer readable medium having computer readable and executable code for instructing one or more processors to perform a method, the method comprising:
storing, in a memory, account information for the user and account information for a plurality of merchants;
receiving, electronically by one or more processors, a communication including an indication of a desire of a user to shop at one or more merchants within a defined area;
accessing, by the one or more processors, the memory to verify that the user is an authorized user and that the merchant(s) are participating merchants; and
sending, by the one or more processors, a pre-authorization to the merchant(s) if the user is an authorized user and the merchant(s) are participating merchants.
